(19) United States
(12) Patent Application Publication
(10) Pub. No.: US 2021/0218283 A1
(43) Pub. Date: Jul. 15, 2021

(54) Wireless power transfer system including primary coil unit having a plurality of independently controllable coils and receiver coil unit having a plurality of coils

(71) Applicant: KOREA ADVANCED INSTITUTE OF SCIENCE AND TECHNOLOGY (KAIST), Daejeon (KR)

(72) Inventors: Dong Ho CHO, Daejeon (KR); Bo Yune SONG, Daejeon (KR); Gu Ho JUNG, Daejeon (KR); Chung Hee LEE, Daejeon (KR); Ja Hyeon LEE, Daejeon (KR); Uoo Yeol YOON, Daejeon (KR)

(21) Appl. No.: 17/215,303

(22) Filed: Mar. 29, 2021

Related U.S. Application Data
(62) Division of application No. 15/822,343, filed on Nov. 27, 2017, now abandoned.

(30) Foreign Application Priority Data
Jul. 18, 2017 (KR) 10-2017-0091154
Jul. 18, 2017 (KR) 10-2017-0091168

(51) Int. Cl. H02J 50/12; G06N 3/08; H01F 38/14; H01F 27/28; B60L 53/12

(52) U.S. Cl. CPC H02J 50/12; G06N 3/08; G06N 3/04; H01F 27/2823; B60L 53/12; H01F 38/14

(57) ABSTRACT

Disclosed are a primary coil unit having four coils independently controllable and a pickup coil unit having four coils also independently controllable. The proposed power transfer system and the proposed power pickup system can satisfy standard compatibility and improve the efficiency of wireless power transmission. The power transfer device is compatible with various types of conventional power pickup systems and capable of expanding compatibility with a new power pickup system to be developed in future by changing the power transfer magnetic flux pattern. The power pickup device is compatible with various types of conventional power transfer systems and capable of expanding compatibility with a power transfer system to be developed in future. The system including both the power transfer device and the power pickup device is more robust against a deviation.

### BACKGROUND OF THE INVENTION

### 1. Field of the Invention

The present invention relates to a primary coil unit having a plurality of coils, a power transfer device for wireless power transmission using the same and a power pickup device, and more particularly, relates to a primary coil unit having four coils which are electrically separated from each other and independently controllable and a power transfer device which is capable of forming various types of power transfer magnetic flux patterns for wireless power transmission using the same. In addition, the present invention relates to a pickup coil unit having four coils which are electrically separated from each other and independently controllable, and a power pickup device which is capable of effectively receiving magnetic fields of various patterns generated from a power transfer device. Furthermore, the present invention relates to a wireless power charging system which is capable of more effectively performing power transfer by using the power transfer device and the power pickup device to change the form of a magnetic field through mode switching when a positional deviation occurs.

### 2. Description of the Related Art

In a wireless power transfer scheme based on a power pickup system including a circular coil and a power transfer system according to the related art, it is difficult to perform a remote charge because the efficiency of the wireless power transmission is greatly reduced when a deviation occurs between the power transfer system and the power pickup system. In addition, the power transfer system and the power pickup system of a wireless power transfer system according to the related art tend to have little or no compatibility with other types of power transfer systems and power pickup systems. Thus, when a different type of a power pickup system is to wirelessly receive power from a power transfer system to be charged, the capacity and efficiency of the charge fall short of those required in the standard.

In recent years, as one scheme for solving such a problem, there has been proposed a power transfer system which is capable of performing remote charging using two primary coils which is current-controllable independently and has more than a certain degree of compatibility within the existing standard space. However, it has been known that the power transfer system has somewhat lower compatibility than a power transfer system having a conventional circular coil at the correct position and deviation of the wireless power transfer standard. As the types of the primary coil and the pickup coil are proposed, there are the DD type in which two primary coils are arranged side by side, the DDQ type in which one circular coil is additionally overlapped with two primary coils arranged side by side, and the BP type in which coils are arranged but partially overlapped with each other. A power pickup device including a power transfer device having such primary coils and a power pickup device having pickup coils have been described in “Adeel Zaheer et al., Investigation of Multiple Decoupled Coil Primary Pad Topologies in Lumped IPT Systems for Interoperable Electric Vehicle Charging, IEEE TRANSACTIONS ON POWER ELECTRONICS, VOL. 30, NO. 4, April 2015”. A power pickup device corresponding to the power transfer device proposed in the literature includes two pickup coils (DD type) arranged side by side.

Accordingly, there is a need to provide a power transfer system capable of satisfying the capacity and efficiency required by the standard, and capable of performing remote charging, which is not provided by a conventional power transfer system having a circular coil. For example, there is a need to provide a power transfer system capable of performing efficient wireless power transmission corresponding to a newly proposed power pickup system such as the DD type pickup coil.

In addition, there is a need to provide a power pickup device capable of satisfying the capacity and efficiency required by the standard and capable of effectively receiving power wirelessly even when there is a large deviation in the magnetic field formed by a conventional power transfer device having a circular coil.

### SUMMARY OF THE INVENTION

It is an object of the present invention to provide a power transfer system and a power pickup system that can satisfy standard compatibility and at the same time improve the efficiency of wireless power transmission even when a large deviation exists, and a wireless power transfer system with integrated power transfer and power reception.

In detail, it is one object of the present invention to provide a power transfer system which is capable of being compatible with various types of conventional power pickup systems and capable of expanding compatibility with different magnetic fields or new power pickup systems to be developed in future by changing the power transfer magnetic flux pattern. In addition, it is another object of the present invention to provide a power pickup system which is capable of being compatible with various types of conventional power transfer systems and capable of expanding compatibility with different magnetic fields or new power transfer systems to be developed in future by changing the state of connecting pickup coils or controlling the phase of a current flowing through the pickup coil.

To achieve the objects, in accordance with one aspect of the present invention, there is provided a method of controlling a wireless power transfer device including four primary coils each of which partially overlaps other adjacent primary coils and is electrically independent from other primary coils, the method comprising: (a) supplying power to the four primary coils such that each of the four primary coils generates a magnetic field having a same intensity in a same direction; (b) sensing a state change of each primary coil when a magnetic field formed by the wireless power transfer device is changed by an adjacent wireless power pickup device; (c) determining a position of the adjacent wireless power pickup device based on information including the state change of each primary coil sensed in the step (b); (d) deciding an operation mode of each primary coil based on the position of the adjacent wireless power pickup device determined in the step (c); and (e) controlling an operation of each primary coil based on the operation mode of each primary coil decided in the step (d).

In accordance with another aspect of the present invention, there is provided a wireless power transfer device comprising:

at least four primary coils each of which partially overlaps other adjacent primary coils and is electrically independent from other primary coils;

a power pickup device position determining unit configured to output information including a position of an adjacent wireless power pickup device when information including a change of a current generated from each of the at least four primary coils is provided as inputs;

a control unit configured to individually control operations of the at least four primary coils by performing: (a) supplying power to said at least four primary coils such that said at least four primary coils generate magnetic fields having a same intensity in a same direction; (b) sensing a state change of each of the at least four primary coils when a magnetic field formed by the wireless power transfer device is changed by the adjacent wireless power pickup device; (c) determining the position of the adjacent wireless power pickup device based on information including the state change of each of said at least four primary coils sensed in the step (b); (d) deciding an operation mode of each of said at least four primary coils based on the position of the adjacent wireless power pickup device decided in the step (c); and (e) controlling an operation of each of said at least four primary coils based on the operation mode of each of said at least four primary coils determined in the step (d).

In accordance with still another aspect of the present invention, there is provided a primary coil unit used in a wireless power transfer device, the primary coil unit comprising: four primary coils each of which partially overlaps with other primary coils and has a rectangular shape, wherein the four primary coils are electrically independent from each other, an aspect ratio of each primary coil is in a range of 1.0 to 1.1, and a ratio of overlapping one side of each primary coil with another adjacent primary coil is in a range of 0.47 to 0.58.

In accordance with still another aspect of the present invention, there is provided a method of controlling a wireless power pickup device including four pickup coils each of which partially overlaps other adjacent pickup coils and is electrically independent from other pickup coils, the method comprising: (a) sensing states of each pickup coils; (b) determining a position of the wireless power pickup device based on information including changes in the states of each pickup coils sensed in the step (a); (c) deciding an operation mode of each pickup coil based on information including the position of the wireless power pickup device determined in the step (b); and (d) controlling an operation of each pickup coil based on the operation mode of each pickup coil decided in the step (c).

In accordance with still another aspect of the present invention, there is provided a wireless power pickup device comprising: at least four pickup coils each of which partially overlaps other adjacent pickup coils and is electrically independent from other pickup coils; a power pickup device position determining unit configured to output information including a position of the wireless power pickup device when information including a change of a current generated from each pickup coil is provided as an input; a control unit configured to individually control an operation of each pickup coil by performing: (a) sensing a state of each pickup coils; (b) determining a position of the wireless power pickup device based on information including the changes in the state of each pickup coil sensed in the step (a); (c) deciding an operation mode of each pickup coil based on information including the position of the wireless power pickup device determined in the step (b); and (d) controlling an operation of each pickup coil based on the operation mode of each pickup coil decided in the step (c).

In accordance with still another aspect of the present invention, there is provided a pickup coil unit used in a wireless power pickup device comprising: four pickup coils each of which partially overlaps with other pickup coils and has a rectangular shape, wherein the four pickup coils are electrically independent from each other, an aspect ratio of each pickup coil is in a range of 1.0 to 1.25, and a ratio of overlapping one side of each pickup coil with another adjacent pickup coil is in a range of 0.5 to 0.8.

According to the present invention, there is provided a power transfer system and a power pickup system capable of satisfying the standard compatibility and improving the efficiency of remote wireless power transmission. In addition, there is provided a wireless power transfer system in which the power transfer system and the power pickup system are combined to maximize the effect.

In addition, according to the present invention, there is provided a power transfer system which is capable of being compatible with various types of conventional power pickup systems and capable of expanding compatibility with different magnetic fields or new power pickup systems to be developed in future by changing the power transfer magnetic flux pattern.

In addition, according to the present invention, there is provided a power pickup system which is capable of being compatible with various types of conventional power transfer systems and capable of expanding compatibility with different magnetic fields or new power transfer systems to be developed in future by changing the state of connecting pickup coils or controlling the phase of a current flowing through the pickup coil.

### BRIEF DESCRIPTION OF THE DRAWINGS

Hereinafter, exemplary embodiments of the present invention for achieving the effects will be described in detail with reference to the accompanying drawings.

FIG. 1 is a diagram showing an induced voltage according to a positional deviation of a standard power pickup device when a power transfer device according to the related art is arranged long in the transverse direction;

FIG. 2 is a diagram showing an induced voltage according to a positional deviation of a standard power pickup device when a power transfer device according to the related art is arranged long in the longitudinal direction;

FIG. 3 is a schematic view of a power transfer device according to an embodiment of the present invention;

FIG. 4 is plan and front views of a primary coil unit of the power transfer device shown in FIG. 3;

FIG. 5 is a schematic view of a resonant capacitor module of the power transfer device shown in FIG. 3;

FIG. 6 is a diagram illustrating an operation mode of the primary coil unit of the power transfer device shown in FIG. 3, where each primary coil of the primary coil unit has a square shape;

FIG. 7 is a diagram showing an operation mode of the primary coil unit of the power transfer device shown in FIG. 3, where each primary coil of the primary coil unit has a rectangular shape;

FIG. 8 is a diagram showing a change in the induced voltage according to the aspect ratio and degree of overlap of the primary coil unit in the power transfer device shown in FIG. 3;

FIG. 9 is a diagram of a power pickup device according to an embodiment of the present invention;

FIG. 10 is a diagram of a pickup coil unit of the power pickup device shown in FIG. 9;

FIG. 11 is a diagram of one pickup coil of the pickup coil unit shown in FIG. 10;

FIG. 12 is a diagram illustrating an operation mode of the pickup coil shown in FIG. 10;

FIG. 13A is a diagram illustrating an operation mode of a pickup coil when a power pickup device according to the present invention is disposed at a position deviated from the center of a standard power transfer device in the y-direction;

FIG. 13B is a diagram illustrating an operation mode of a pickup coil when a power pickup device according to the present invention is disposed at a position deviated from the center of a standard power transfer device in the x-direction;

FIG. 13C is a diagram illustrating an operation mode of a pickup coil when a power pickup device according to the present invention is disposed at a position diagonally deviated from the center of a standard power transfer device;

FIG. 14 is a graph illustrating a voltage induced to a power pickup device when a power pickup device according to the present invention is deviated from the center of the a standard power transfer device;

FIG. 15 is a flowchart illustrating a method of obtaining a position of a power pickup device by a power transfer device according to present invention;

FIG. 16 is a flowchart illustrating the detailed steps of step S120 of FIG. 15;

FIG. 17 is a flowchart illustrating a method of obtaining the position of a power pickup device by the power pickup device according to the present invention;

FIG. 18 is a graph illustrating a change of an induced voltage according to a positional deviation of a power receiving device when the power transfer device and power pickup device according to the present invention are combined with each other;

FIG. 19A is a diagram illustrating the change of the operation mode of a power pickup device according to a positional deviation of a power transfer device according to the present invention when the power pickup device according to the present invention is in an all-mode;

FIG. 19B is a diagram illustrating the change of the operation mode of a power pickup device according to a positional deviation of a power transfer device according to the present invention when the power pickup device according to the present invention is in an all-mode;

FIG. 19C is a diagram illustrating the change of the operation mode of a power pickup device according to a positional deviation of a power transfer device according to the present invention when an operation mode of the power pickup device according to the present invention is changed;

FIG. 19D is a diagram illustrating the change of the operation mode of a power pickup device according to a positional deviation of a power transfer device according to the present invention when an operation mode of the power pickup device according to the present invention is changed;

FIG. 20 is a diagram illustrating a positional deviation between a standard power pickup system and a power pickup system according to the present invention; and

FIG. 21 is a diagram illustrating an operation of a switch in each mode of a primary coil when a shared-capacitor module shown in FIG. 5 is used.

### DETAILED DESCRIPTION OF THE INVENTION

Hereinafter, an embodiment of the present invention will be described in detail with reference to accompanying drawings. In the following description, specific details are merely provided to assist the overall understanding of exemplary embodiments of the present invention. Therefore, it should be apparent to those skilled in the art that various changes and modifications of the embodiments described herein can be made without departing from the scope and spirit of the invention. In a description of the present invention, a detailed description of related known functions and configurations will be omitted when it may make the essence of the present invention unnecessarily obscure. Further, parts irrelevant to the present invention are omitted in the drawings to make the present invention clear and the same reference numerals are designated to the same or similar components throughout the specification.

Power Transfer Device

Configuration of Power Transfer Device

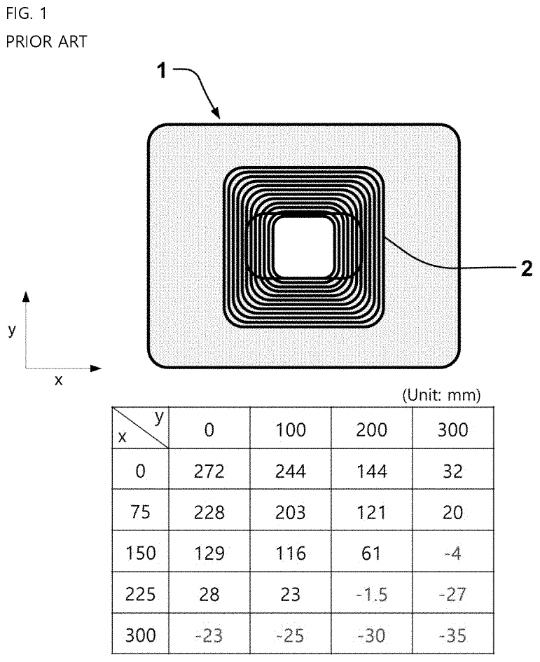

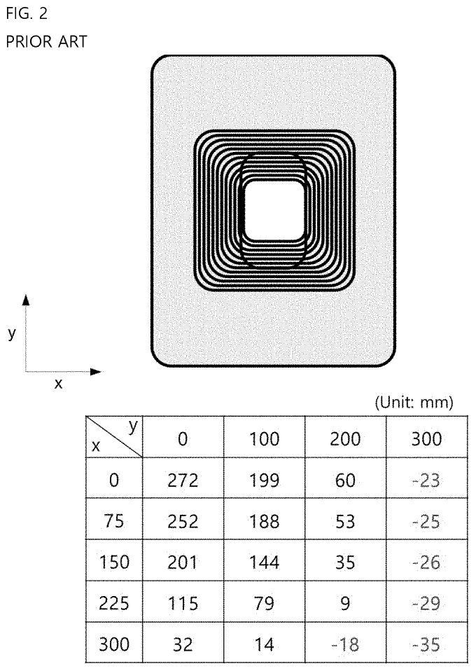

FIG. 1 illustrates a standard power transfer/pickup system in which a power pickup device 2 moves in the x-direction and y-direction with respect to the center of a power transfer device 1 after the power transfer device 1 is arranged long in a transverse direction, and shows the results of calculating a voltage induced to the power pickup device 2 through a simulation. FIG. 2 illustrates the standard power transfer/pickup system in which the power pickup device 2 moves in the x-direction and y-direction with respect to the center of the power transfer device 1 after the power transfer device 1 is arranged long in a longitudinal direction, and shows the results of calculating a voltage induced to the power pickup device 2 through a simulation. In FIGS. 1 and 2, a box filled with a red letter means that a counter voltage is generated in the power pickup device 2.

Meanwhile, although the standards for parking areas vary from country to country, the width is specified in the range of 2.0 m to 2.6 m and the length is specified in the range of about 5 m to about 6 m. Generally, in the case of a compact vehicle, the width is about 1.6 m. In the case of a semi-midsize vehicle, the width is about 1.8 m. Thus, when the battery of a vehicle is charged through wireless power transmission, a deviation of about 0.1 m to about 0.5 m may be generated between a power transfer device and a power pickup device.

Accordingly, in a standard power transfer/pickup system, when a deviation occurs between the positions of a power transfer device and a power pickup device, the induced power is greatly reduced even though the deviation is small. When the deviation is large, a counter voltage may be generated.

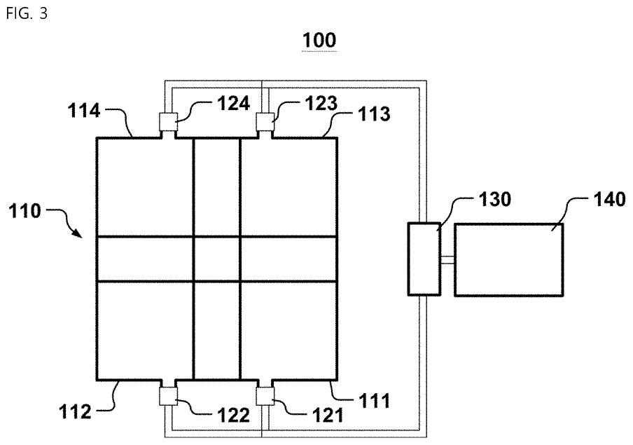

FIG. 3 schematically shows a primary coil unit 110 having four coils according to an embodiment of the present invention and a power transfer device 100 using the same. The power transfer device 100 includes a primary coil unit 110 having four primary coils 111 to 114, a resonant capacitor module 130, an inverter 140 and four switches 121 to 124 connecting each coil 111 to 114 to the inverter 140 via the resonant capacitor module 130.

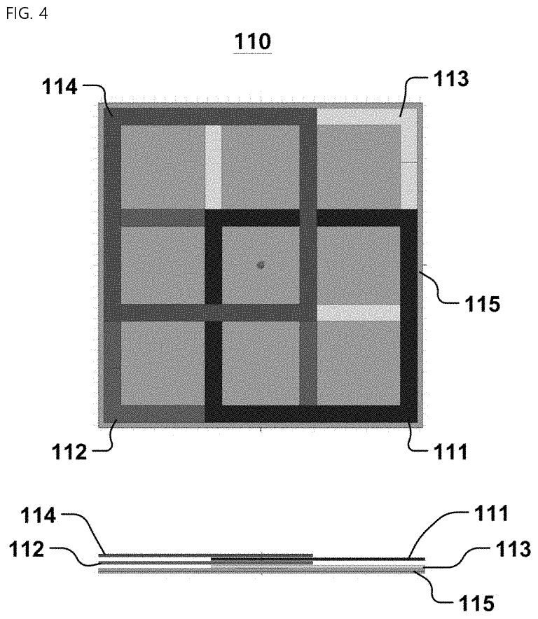

One example of the primary coil unit 110 of FIG. 3 is shown in FIG. 4. The same reference numerals are designated to the same components. Reference numeral 15 represents a power transfer core 115. The four primary coils 111 to 114 depicted in FIG. 4, each of which has a substantially rectangular shape, are arranged such that the internal areas formed by each primary coil are partially overlapped with each other. The primary coils have the rectangular shapes of the same size. However, the shape of the primary coil is not necessarily limited to the rectangular shape but may be variously modified corresponding to a required magnetic flux pattern. In addition, in the embodiment depicted in FIG. 4, although the primary coils are overlapped in the same manner, the overlap manner may be variously modified corresponding to a required magnetic flux pattern. The four primary coils of the primary coil unit are stacked on the power transfer core 115 in the sequence of the third primary coil 113, the second primary coil 112, the first primary coil 111 and the fourth primary coil 114. A shape maintaining member (not shown) for maintaining the shape of each primary coil may be provided in the space inside each primary coil. It is obvious that the primary coils may be arranged in other manners.

Each of the primary coils 111 to 114 is connected to the inverter 140 through the medium of the switches 121 to 124. For example, each of the switches 121 to 124 may be formed to switch the direction of the power suppled to each primary coil 111 to 114 or shut off the power. Thus, high-frequency power having the same phase or an opposite phase may be provided to each primary coil 111 to 114 by the switching operation of each switch or the power supply may be shut off. Each of the primary coils 111 to 114 is connected to the inverter 140 through the medium of the resonant capacitor module 130.

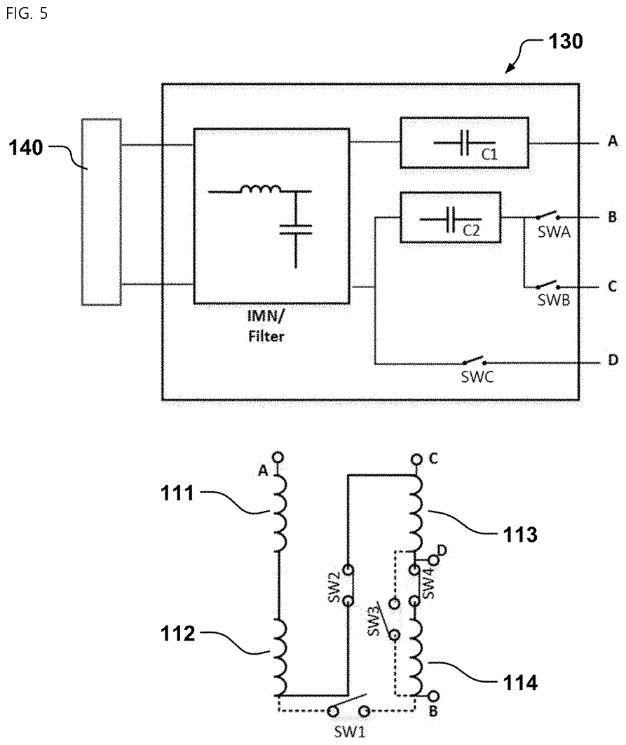

FIG. 5 substantially shows one example of the resonant capacitor module 130 and the electrical connection between each primary coil 111 to 114 and the resonant capacitor module 130. In FIG. 5, the primary coils 111 to 114 and the switches SW1 to SW4 are connected to each other in a manner different from that depicted in FIG. 3. The switches SWA, SWB and SWC in the resonant capacitor module 30 may be electrically controlled. Several operation modes of the power transfer device 100 according to an individual operation of each primary coil 111 to 114 will be described in detail below.

Operation Mode of Primary Coil

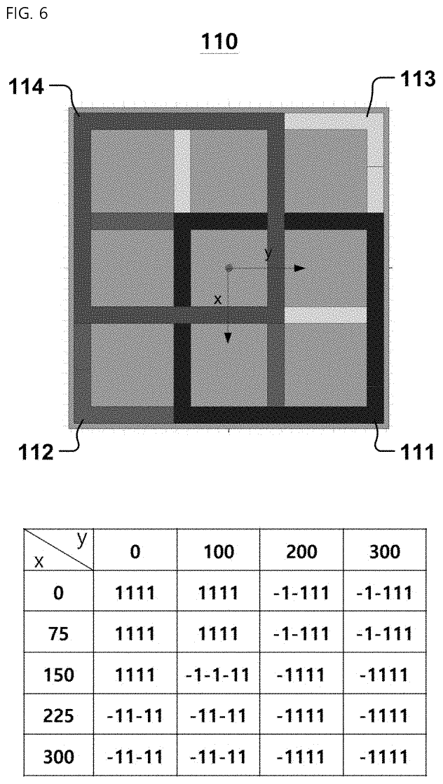

FIG. 6 shows the direction of the current applied to each primary coil 111 to 114 when the most advantageous induced voltage is generated as the position of the standard power pickup device is changed in the x-direction and the y-direction with respect to the central position of the primary coil unit 110 according to an embodiment of the present invention. In detail, the direction of the current supplied to each primary coil has been controlled such that a section in which the voltage induced to the standard power pickup device is opposite and a dead section in which any induced voltage do not exist are non-existent.

In the table of FIG. 6, a 4-digit number represents the direction of a current applied to each primary coil, and the first to fourth primary coils are denoted in order. That is, for example, “1 1−1 −1” represents that a clockwise current is applied to the first and second primary coils 111 and 112 and a counterclockwise current is applied to the third and fourth primary coils 113 and 114.

When sorting modes are confirmed through a simulation by type, there are three types of modes: quarter mode, all mode and half mode. In the quarter mode, the direction of the current flowing through one of the four primary coils is different from those of currents flowing through the remaining primary coils, which are the same. In the half mode, the directions of currents flowing through the primary coils adjacent to each other in a transverse or longitudinal direction are the same. In the all mode, the directions of currents flowing through the four primary coils are the same. In each mode, there is a case where the directions of the currents flowing through the coils, which are electrically symmetric to each other, are opposite to each other. Thus, the primary coil is operated in eight quarter modes, four half modes and two all modes, that is, a total of 14 operation modes.

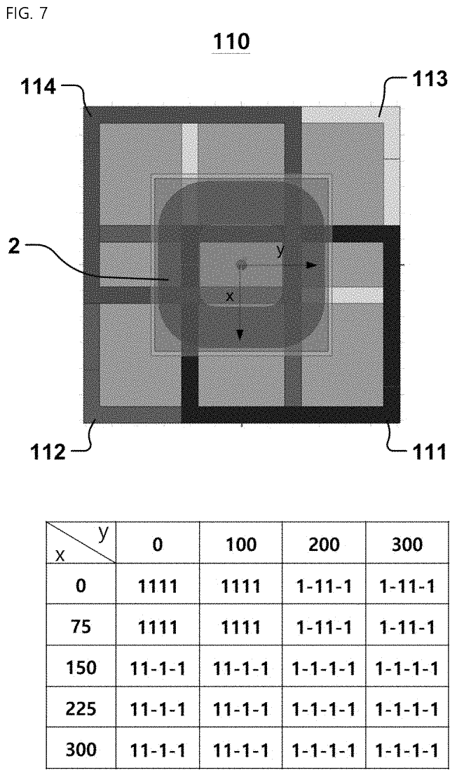

In the case where the primary coil has a rectangular shape, the operation mode of the primary coil for generating an induced voltage which is most favorable to the standard power pickup device is changed. For example, FIG. 7 shows the direction of the current supplied to each primary coil such that a section in which the voltage induced to the standard power pickup device is opposite and a dead section in which any electromotive forces do not exist are non-existent. When compared with FIG. 6, it is known that the direction of the current supplied to each primary coil is changed.

Shape and Arrangement of Primary Coil

The primary coils shown in the above-mentioned drawings have a rectangular shape and are partially overlapped with each other. Hereinafter, the variation of a magnetic field generated by the primary coils according to the shape of the primary coils and the overlap areas will be described.

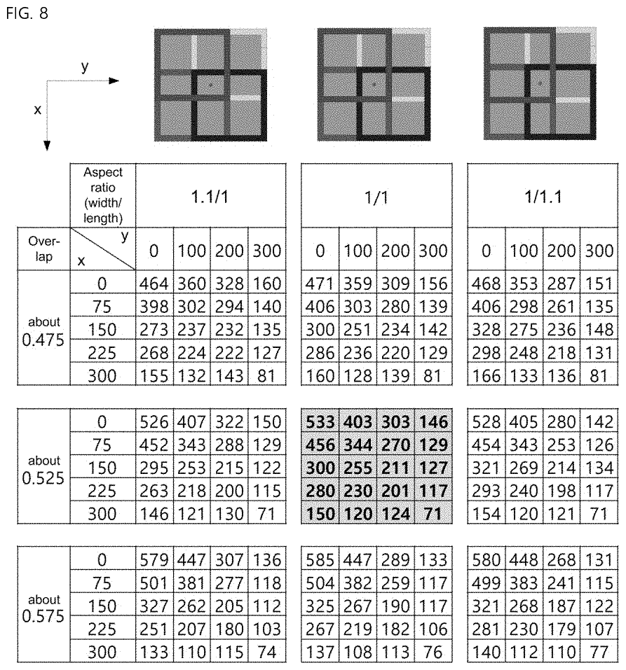

FIG. 8 shows a table filled with the results of calculating voltage induced to the standard power pickup device through a simulation while changing the aspect ratio and degree of overlap of the primary coil. For comparison, the mass of the conductor included in each primary coil is kept the same even though the aspect ratio is changed. The degree of overlap is changed by moving each coil by the same distance in the x-direction and y-direction toward the center of the primary coil unit 110.

The simulation results are summarized as follows:

1) Although the induced voltage is increased as the degree of overlap is increased when the standard power pickup device is in position to match the center of the power transfer device, the degree of reduction of the induced voltage is increased when the positional deviation of the standard power pickup device is increased.

2) Regarding the aspect ratio, even if the aspect ratio is not changed greatly, the voltage induced to the standard power pickup device varies greatly.

3) Regarding the shape of the primary coil, it is judged that the primary coil is advantageous in the case of a rectangular shape rather than a square shape. However, the difference between the voltages induced to the standard power pickup device according to the shape of the primary coil is not large. Considering the manufacturing conditions of the primary coil, the primary coil may have a square shape.

The range of each variable in the embodiments illustrated based on the aspect ratio and the degree of overlap of the primary coil unit 110 confirmed in the simulation is as follows: the aspect ratio is in the range of about 1.0 to about 1.1 and the degree of overlap is in the range of about 0.25 to about 0.55 based on the inner area of each primary coil.

Power Pickup Device

Configuration of Power Pickup Device

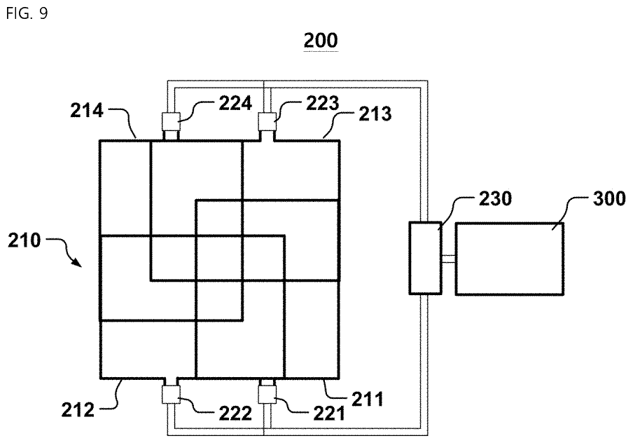

FIG. 9 is a schematic view showing a pickup coil unit 210 having four coils and a power pickup device 200 using the same according to an embodiment of the present invention. The power pickup device 200 includes a pickup coil 210 having four pickup coils 211 to 214, a rectifier module 230. Each of the pickup coils 211 to 214 is connected to the rectifier module 230 through each switch 221 to 224. The rectifier module 230 provides direct current power to a load resistor or a battery 300.

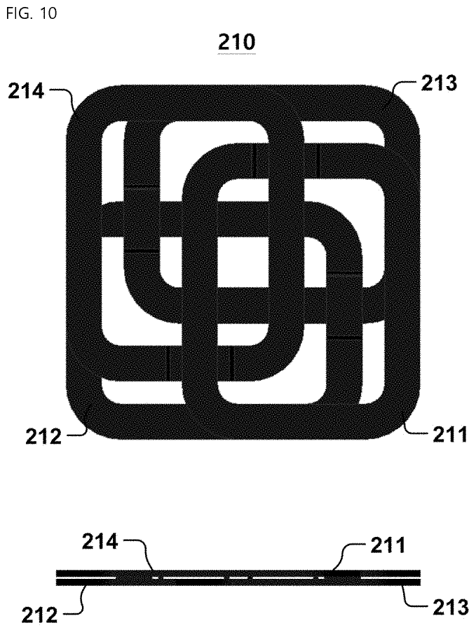

FIG. 10 shows one example of the primary coil unit 210 depicted in FIG. 9. The same reference numerals are designated to the same components. A power pickup core is not depicted for the purpose of convenient description. Each of the pickup coils 211 to 214 depicted in FIG. 10 has a substantially rectangular shape, and the coils are arranged to allow the inner areas formed by the coils to partially overlap each other. In addition, the coils have rectangular shapes of the same size. The shape of the pickup coil is not limited to the rectangular shape but may be variously modified corresponding to a required magnetic flux pattern. In addition, In addition, although the coils are overlapped with each other in the same manner in the embodiment depicted in FIG. 10, the embodiment may be variously modified in such a manner that the coils are overlapped with each other corresponding to the required magnetic flux pattern.

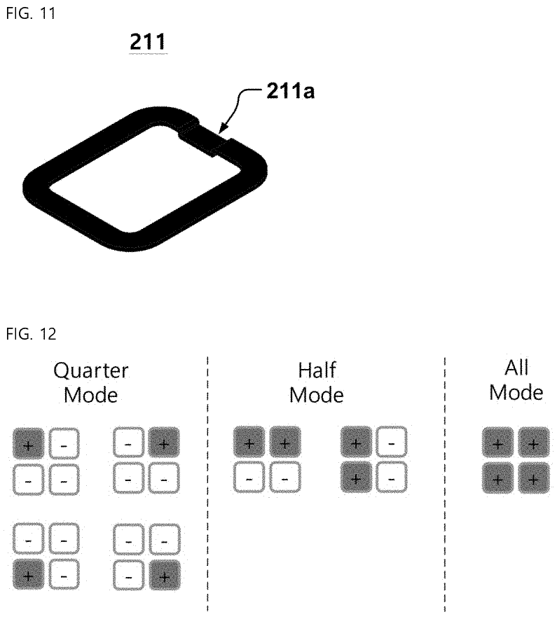

FIG. 11 shows one 211 of the four pickup coils of the pickup coil unit 210. The pickup coil 211 having a rectangular shape has a concave portion 211a formed by concaving one of two short sides. The concave portion 211a is formed at a position at which the concave portion 211a is overlapped with another pickup coil, so that the height of the pickup coil unit 210 is prevented from rising even if the four pickup coils are overlapped with each other. Since the pickup coil unit 210 is disposed on a lower portion of the vehicle, a lower height is advantageous.

Each of the pickup coils 211 to 214 is connected to the rectifier module 230 through the switches 221 to 224. For example, each switch 221 to 224 is formed to switch the direction of power output from each pickup coil 211 to 214. By the switching operations of the switches, the phases of the powers output from the pickup coils 211 to 214 may be the same or opposite to each other. Unlike the primary coil, the power output from the pickup coil is not cut off.

Operation Mode of Pickup Coil

FIG. 12 shows all operable modes of the pickup coil unit 210 according to an embodiment of the present invention. In the quarter mode, the direction of the current induced to one of the four pickup coils is different from the directions of the currents induced to the remaining pickup coils, which are the same. In the half mode, the currents flowing in the same direction are induced to the pickup coils adjacent to each other in the transverse or longitudinal direction. In the all-mode, the currents flowing in the same direction are induced to all the four pickup coils. In each mode depicted, there exist currents electrically symmetrical to each other, that is, flowing through the coils in opposite directions. Thus, as the operation modes of the pickup coil, there are a total of 14 operation modes consisting of eight quarter modes, four half modes and two all-modes.

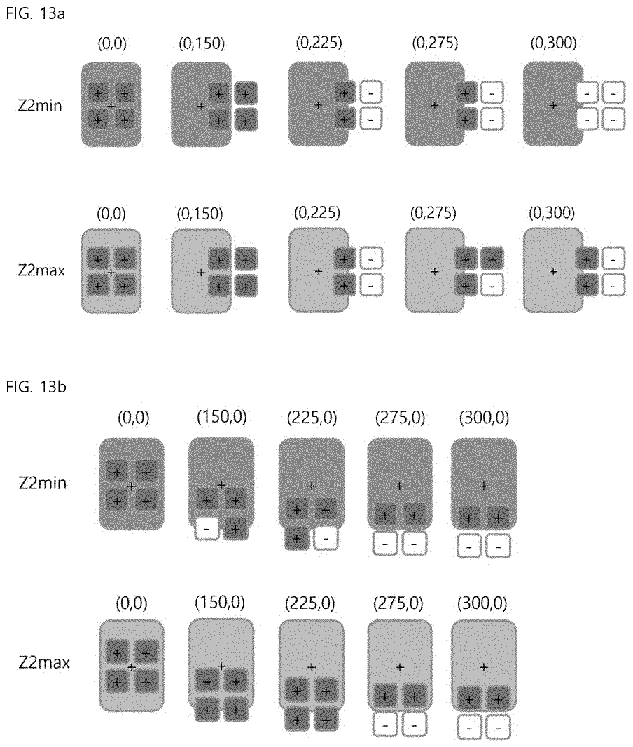

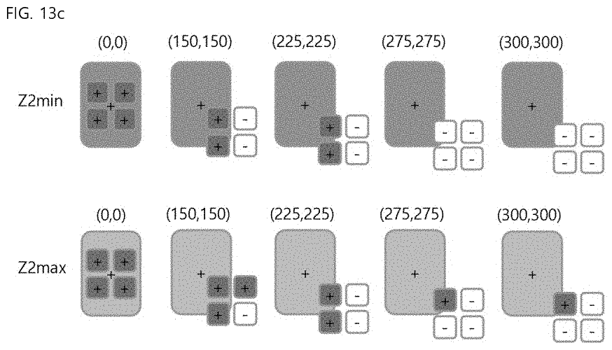

FIGS. 13A to 13C show the operation modes in which the highest voltage is induced from the standard power transfer device according to the position of the pickup coil according to the present invention and is calculated and confirmed through a simulation. In the drawings, ‘Z2 min’ and ‘Z2 max’ represent the degree that the pickup coil is vertically away from the primary coil, and the numbers in parenthesis represent the distances, in millimeters, from the center of the primary coil to the pickup coil in the x-direction and y-direction.

As shown in FIG. 13A, as the pickup coil according to the present invention goes away from the center of the standard primary coil in the y-direction while maintaining the vertical position of ‘Z2 min’, the operation mode of the pickup coil is changed in the order of the all-mode, the half mode and the quarter mode. This manner is substantially the same as in the vertical position of ‘Z2 max’, but the quarter mode is only shown at position (0,275).

As shown in FIG. 13B, as the pickup coil according to the present invention goes away from the center of the standard primary coil in the x-direction while maintaining the vertical position of ‘Z2 min’, the operation mode of the pickup coil is changed in the order of the all-mode, the quarter mode and the half mode. At the vertical position of ‘Z2 max’, the all-mode is changed to the quarter mode. As shown in FIG. 13C, as the pickup coil according to the present invention goes away from the center of the standard primary coil in the diagonal direction while maintaining the vertical position of ‘Z2 min’, the operation mode of the pickup coil is changed in the order of the all-mode (+), the half mode and the all-mode (−). At the vertical position of ‘Z2 max’, the operation mode is changed in the order of the all-mode, the quarter mode, the half mode and the quarter mode.

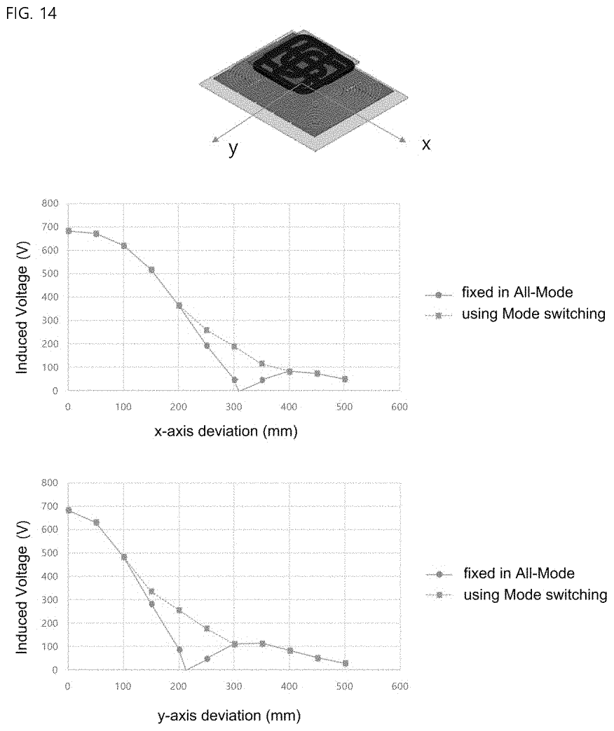

FIG. 14 is a graph showing a simulation result of the voltage induced by the pickup coil according to the present invention at each position in the x-axis and the y-direction in accordance with the mode of the pickup coil with respect to the standard primary coil. As shown, when the pickup coil is maintained in the all-mode, the dead section, in which the voltage induced to the pickup coil is (zero) is shown. However, when the mode of the pickup coil is suitably changed, it is known that the dead section is not shown.

Shape and Arrangement of Pickup Coil

The pickup coils shown in the above-described drawings have a rectangular shape and are partially overlapped with each other. When the degree of overlap of the pickup coil is changed, the induced voltage is increased when the pickup coil is located at the position coinciding with the center of the power transfer device as the degree of overlap increases, but the degree of decrease in the induced voltage is increased when the positional deviation of the power pickup device is increased.

In the illustrated embodiment, the pickup coil has a rectangular shape, but may have a square shape. However, as a result of the simulation, it was found that it is advantageous that the inner area of the pickup coil is overlapped with a certain area. When the aspect ratio of the pickup coil and the degree of overlap are summarized by taking this into consideration, the aspect ratio is in the range of about 1 to about 1.25, and the degree of overlap of the inner area of the pickup coil with respect to the long side of the pickup coil is preferably in the range of about 0.35 to about 0.65.

Control Method

Method of Controlling Power Transfer Device

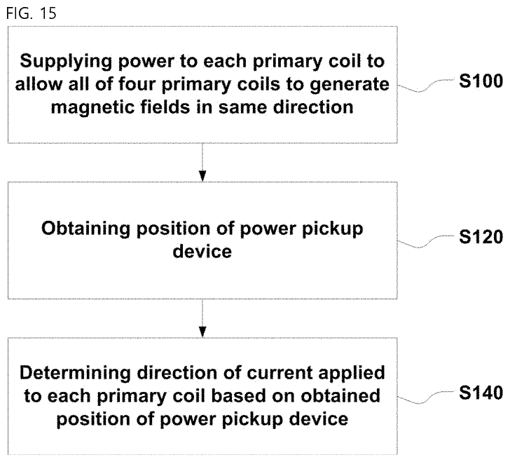

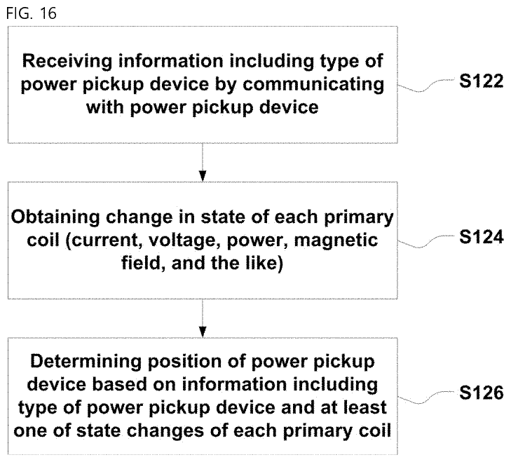

FIGS. 15 and 16 illustrate a method of controlling a power transfer device having four primary coils according to the present invention.

As shown in FIG. 15, the method of controlling a power transfer device includes: step S100 of supplying power to the four primary coils such that each of the four primary coils generates a magnetic field of the same magnitude in the same direction, step S120 of obtaining a position of an adjacent power pickup device; and step S140 of determining an operation mode of each primary coil based on the position of the adjacent wireless power pickup device. Based on the operation mode of each primary coil determined as described above, the operation of each primary coil is controlled.

In step 120, the position of the adjacent power pickup device is obtained by performing the method depicted in FIG. 16 as follows. The method includes step S122 of receiving information including the type of the power pickup device by communicating with the power pickup device, step S124 of obtaining a change in the state of each primary coil, and step S126 of determining the position of the adjacent wireless power pickup device based on the information including the change in the state of each primary coil obtained. In this case, the change in the state of each primary coil includes at least one of a change in a current flowing through each primary coil, a change in an applied voltage, a change in power, and a change in a magnetic field. In step S126, the position of the power pickup device may be obtained by considering the received information including the type of the power pickup device.

When the power pickup device includes a plurality of pickup coils, information about the change in the state of each pickup coil, such as a voltage, a current, a power, a magnetic field, or the like, generated by the magnetic field formed by the power transfer device may be included in the information including the type of the power pickup device in step S210. Such a change in the state of the pickup coil may occur when the position of the pickup coil is not changed, and may occur as the power pickup device installed in a vehicle approaches from a remote position to the power transfer device. When the state of the pickup coil is changed as a vehicle approaches to the power transfer device, the information about the movement of the vehicle may be further transmitted to the power transfer device.

When the communication with the power pickup device is not performed, the position of the power pickup device may be determined based only on the state change of each primary coil.

In step S126, various schemes may be utilized to obtain the position of the power pickup device based on given information. In the present invention, based on simulation or experiment data, a machine learning technique such as a support vector machine or a neural network algorithm such as CNN or RNN.

When a case of using the neural network algorithm is explained as an example, a power pickup device position determining unit may be formed by performing supervised learning which includes the change of a current generated in each primary coil of the power transfer device by the adjacent power pickup device as an input and the position of the adjacent power pickup device as an output. When the information including the change of a current generated from each primary coil of the power pickup device position determining unit is provided as an input, the power pickup device position determining unit outputs the information including the position of the adjacent wireless power pickup device. The input of the neural network algorithm may include information about the type of the adjacent power pickup device and/or the state of the pickup coil changed by the magnetic field formed by the power transfer device.

Method of Controlling Power Pickup Device

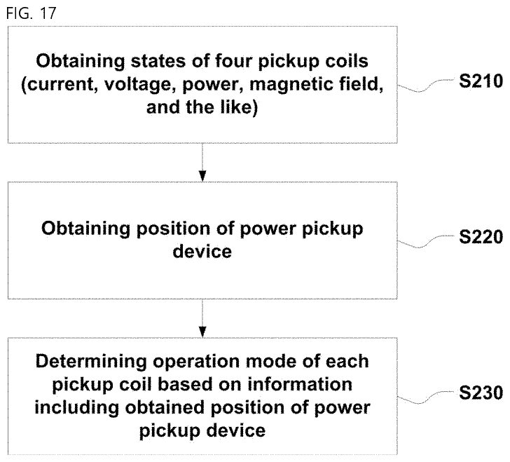

FIG. 17 illustrates a method of controlling an operation mode of each pickup coil in the power pickup device according to the present invention.

First, in step S210, the states of the four pickup coils of the power pickup device are sensed. To this end, power is supplied in advance to the power transfer device to form a magnetic field and the state of each pickup coil is changed by the magnetic field. The state of the pickup coil includes at least one of a current, a voltage, a power, and a magnetic field. The state of the pickup coil may be detected in the state where the pickup coil is stopped, or may be obtained continuously while the vehicle in which the pickup coil is installed approaches from a remote position to the power transfer device.

Next, in step S220, the position of the power pickup device is determined based on only the state of each pickup coil sensed in step S210 or considering additional information together. The additional information includes information about the type of the power transfer device or the like.

In step S230, when the position of the power pickup device is obtained, the operation mode of each pickup coil is determined using the information or the additional information together. In this case, the additional information may include information about the operation mode of the power transfer device when the power feeding device is a type capable of switching the operation mode. The reason is that the state of the pickup coil is changed according to the operation mode of the power transfer device.

When the operation mode of each pickup coil is determined, the operation of the each pickup coil is controlled according to the determined operation mode.

In step S210, the power pickup device may include a power pickup device position obtaining unit for obtaining the position of the power pickup device. Like the power transfer device position obtaining unit, the power pickup device position obtaining unit utilizes a machine learning technique or a neural network algorithm.

For example, when the neural network algorithm is utilized, supervised learning including the state of each pickup coil of the power pickup device as an input and the position of the wireless power pickup device as an output is performed. When the information including the state of each pickup coil of the power pickup device is provided by the neural network algorithm as the input, the information including the position of the wireless power pickup device is output.

Control of Power Transfer Device and Power Pickup Device

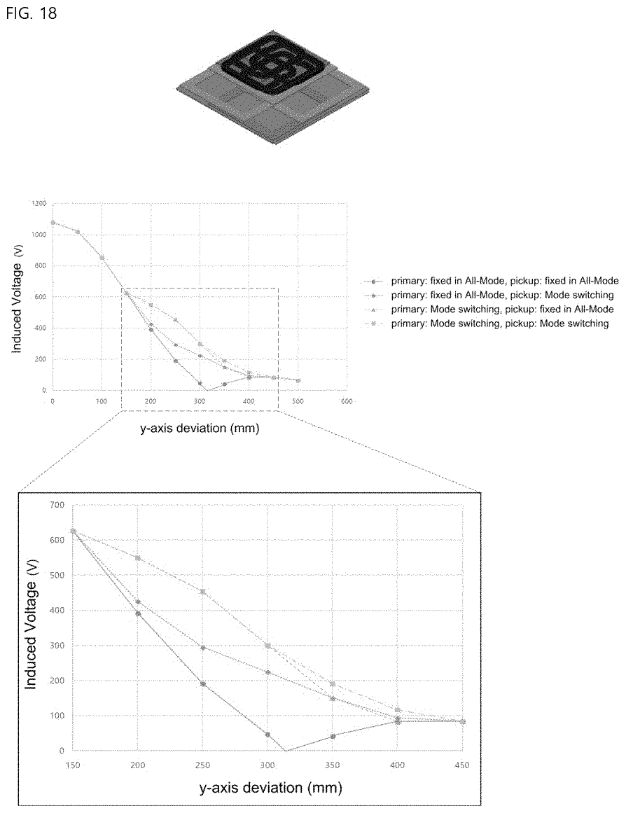

FIG. 18 shows the induced voltage generated in the power pickup device according to the operation mode of each device when the power transfer device and the power pickup device according to the present invention are used together.

As shown in FIG. 18, in a state where the power transfer device and the power pickup device are fixed in the all-mode, there is a dead section in which no induced voltage is generated according to the position of the power pickup device. When the power transfer device is fixed in the all-mode and the operation mode of only the power pickup device is switched, there are no dead sections. When the operation mode of the power transfer device is switched, the induced voltage generated in the power pickup device is further increased, and when the operation modes of the power transfer device and the power pickup device are switched, the induced voltage of the power pickup device is somewhat increased.

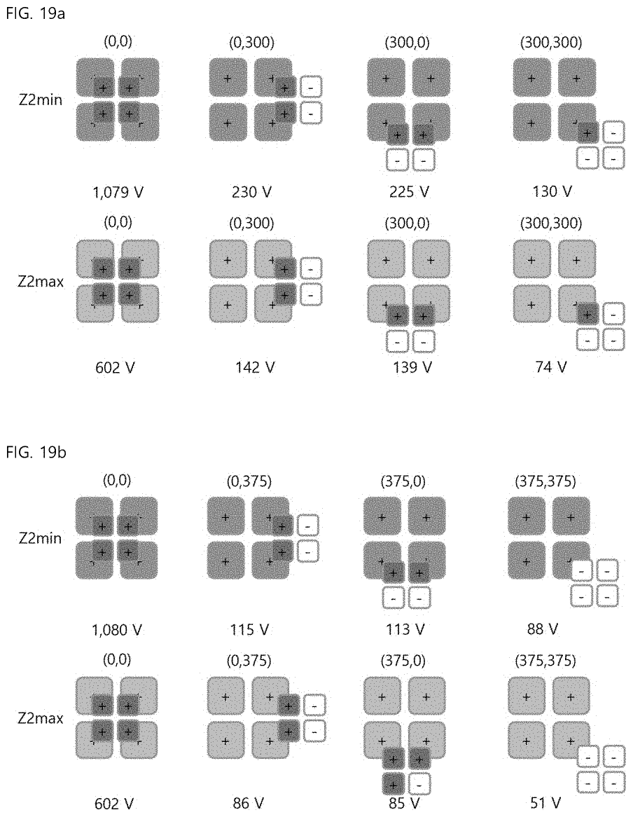

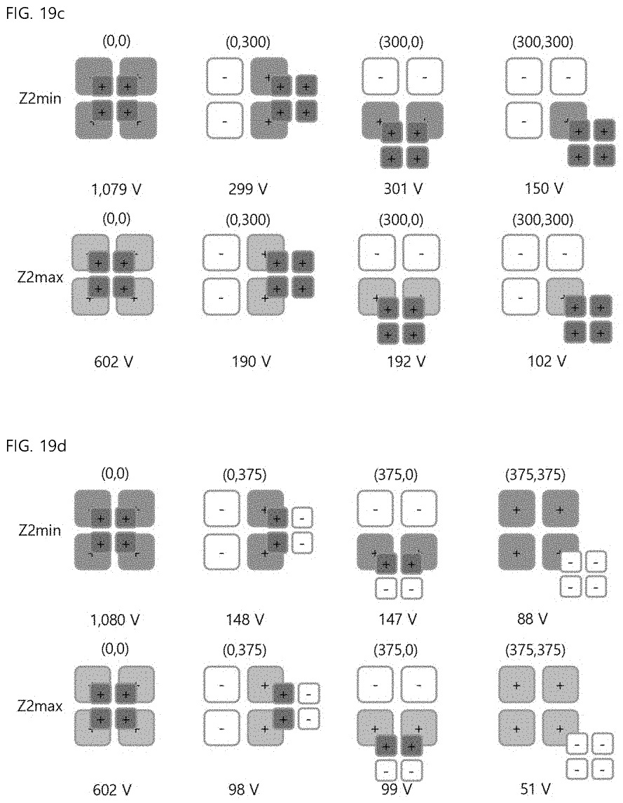

FIGS. 19A to 19D show how the case where the operation mode of the power transfer device is switched or not affects the position and the operation mode of the power pickup device.

Referring to FIGS. 19A and 19B, when the power transfer device is in the all-mode, the power pickup device is operated in the half mode or quarter mode at a position apart by 300 mm or 375 mm in the x-direction or the y-direction. The power pickup device is operated in the quarter mode or all-mode at a position apart in the diagonal direction. To the contrary, referring to FIGS. 19C and 19D, the power pickup device is operated in the all-mode at a position apart by 300 mm in the y-direction and is operated in the half mode or all-mode at a position depart by 375 mm.

Referring to FIGS. 19A to 19D, it was known that the voltage induced to the power pickup device is increased when the operation mode of the power transfer device is switched.

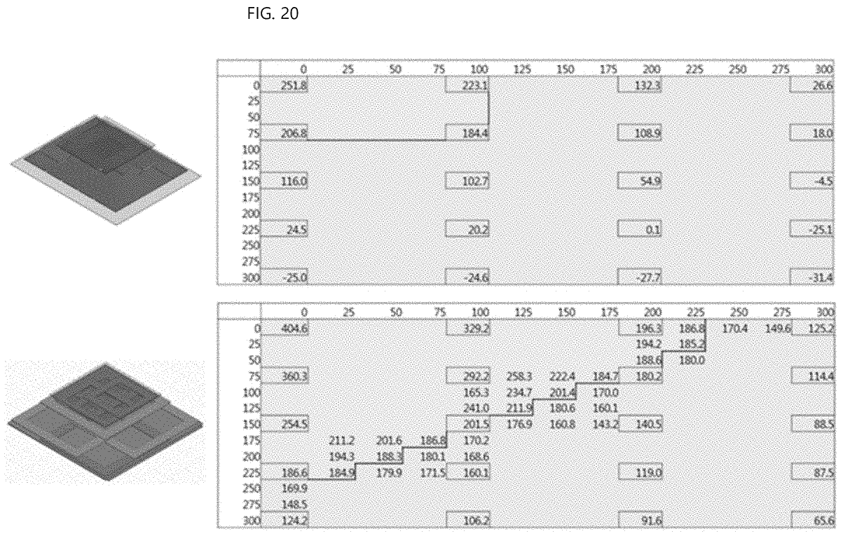

FIG. 20 shows the simulation results of the voltage induced to the power pickup device in the coil according to the present invention at each position in the combination of the standard power transfer device and the standard power pickup device and the combination of the power transfer device and the power pickup device according to the present invention. In the case of the device according to the present invention, this figure shows a result of switching both the operation modes of the power transfer device and the power pickup device.

As shown in the drawings, in the case of using the power transfer device according to the present invention and the power pickup device according to the present invention, as compared with the case of using the power transfer device and the power pickup device according to the standard, the voltage induced to the power pickup device is still high even when a deviation occurs in the position of the power pickup device. Therefore, according to the present invention, it is possible to obtain a wireless power transfer system robust against the positional deviation of the power pickup device.

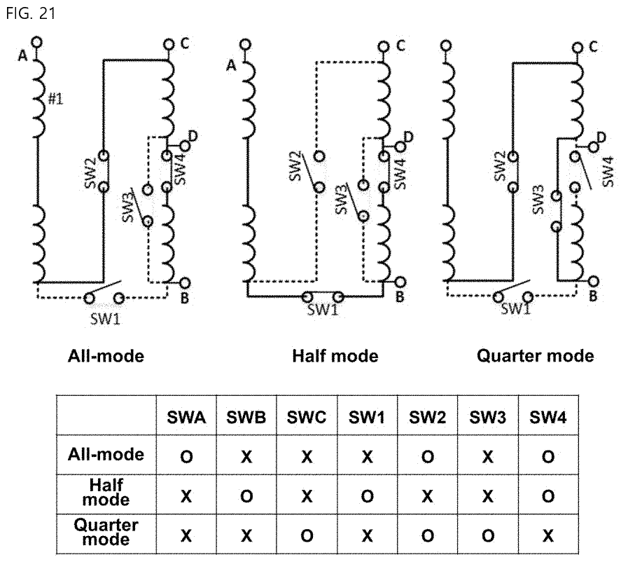

FIG. 21 shows how each of the switches is operated to switch the operation mode of each primary coil of the power transfer device according to the embodiment of the present invention. As shown in the drawing, in order to operate the primary coil in the all-mode, SWA, SW2 and SW4 are closed and the remaining switches are opened. In order to operate the primary coil in the half mode, SWB, SW1 and SW4 are closed and the remaining switches are opened. In order to operate the primary coil in the quarter mode, SWC, SW2, SW3 are closed and the remaining switches are opened.

The resonant capacitor module shown in FIG. 21 is applicable not only to the power transfer device but also to the power pickup device. That is, as shown, the resonant capacitor module and the switch may be provided between each pickup coil and the rectifier module.

It should be noted that the present invention is not limited to the specific forms mentioned in the detailed description of the present invention and includes all modifications and equivalents, and replacements that are within the spirit and range of the present invention, which are defined in the annexed claims.

For example, although it has been described that the phase of the current supplied to the primary coil is changed by 180 degrees by switching of the switch, the present invention is not necessarily limited thereto and the phase of the current may be continuously changed by using a phase shifter. Similarly, although it has been described that the phase of the current output from the pickup coil is changed by 180 degrees by the switch, the phase of the output current may be continuously changed by using the phase shifter.

What is claimed is:

1. A method of controlling a wireless power transfer device including four primary coils each of which partially overlaps other adjacent primary coils and is electrically independent from other primary coils, the method comprising:
(a) supplying power to the four primary coils such that each of the four primary coils generates a magnetic field having a same intensity in a same direction;
(b) sensing a state change of each primary coil as a magnetic field formed by the wireless power transfer device is changed by an adjacent wireless power pickup device;
(c) determining a position of the adjacent wireless power pickup device based on information including the state change of each primary coil sensed in the step (b);
(d) deciding an operation mode of each primary coil based on the position of the adjacent wireless power pickup device determined in the step (c); and
(e) controlling an operation of each primary coil based on the operation mode of each primary coil decided in the step (d),
wherein an aspect ratio of each primary coil is in a range of 1.0 to 1.1 and a ratio of overlapping one side of each primary coil with another adjacent primary coil is in a range of 0.47 to 0.58.

2. The method of claim 1, wherein the state change of each primary coil includes the change of the current generated in each primary coil.

3. The method of claim 1, wherein, in step (c), information for determining the position of the adjacent wireless power pickup device includes information about a kind of the adjacent wireless power pickup device.

4. The method of claim 1, wherein, in the step (c), information for determining the position of the adjacent wireless power pickup device includes information about a state of a current induced to a pickup coil of the adjacent wireless power pickup device.

5. The method of claim 1, wherein the wireless power transfer device includes a power pickup device position determining unit which uses a deep learning algorithm trained based on simulation or experiment data, and
wherein, during the training of the power pickup device position determining unit, a change of a current generated in each primary coil of the wireless power transfer device by the adjacent wireless power pickup device is provided as an input and the position of the adjacent wireless power pickup device as a label.

6. The method of claim 1, wherein, in step (d), the operation mode of each primary coil is decided such that any induced voltage to the adjacent wireless power pickup device is not zero (0).

7. A wireless power transfer device comprising:
at least four primary coils each of which partially overlaps other adjacent primary coils and is electrically independent from other primary coils;
a power pickup device position determining unit configured to output information including a position of an adjacent wireless power pickup device when information including a state change of each primary coil is provided as an input;
a control unit configured to individually control operations of said at least four primary coils by performing:
(a) supplying power to said at least four primary coils such that said at least four primary coils generate magnetic fields having a same intensity in a same direction;
(b) sensing a state change of each of said at least four primary coils as a magnetic field formed by the wireless power transfer device is changed by the adjacent wireless power pickup device;
(c) receiving, from the power pickup device position determining unit, information including a position of an adjacent wireless power pickup device;
(d) deciding an operation mode of each of said at least four primary coils based on the position of the adjacent wireless power pickup device decided in the step (c); and
(e) controlling an operation of each of said at least four primary coils based on the operation mode of each of said at least four primary coils determined in the step (d),
wherein an aspect ratio of each primary coil is in a range of 1.0 to 1.1 and a ratio of overlapping one side of each primary coil with another adjacent primary coil is in a range of 0.47 to 0.58.

8. The wireless power transfer device of claim 7, wherein the input for the power pickup device position determining unit includes information of the change of the current generated in each of said at least four primary coils of the wireless power transfer device.

9. The wireless power transfer device of claim 7, further comprising a communication unit configured to communicate with the adjacent wireless power pickup device.

10. The wireless power transfer device of claim 9, wherein the input for the power pickup device position determining unit includes information about a kind of the adjacent wireless power pickup device.

11. The wireless power transfer device of claim 9, wherein the input for the power pickup device position determining unit includes information about a state of a current of a power pickup coil of the adjacent wireless power pickup device.

12. The wireless power transfer device of claim 7, wherein, in step (d), the operation mode of each primary coil is decided such that any induced voltage to the adjacent wireless power pickup device is not zero (0).

13. The method of claim 7, wherein the power pickup device position determining unit is trained using a deep learning algorithm based on simulation or experiment data, and
wherein, during the training of the power pickup device position determining unit, a change of a current generated in each primary coil of the wireless power transfer device by the adjacent wireless power pickup device is provided as an input and the position of the adjacent wireless power pickup device as a label.
